(19) United States
(12) Patent Application Publication
(10) Pub. No.: US 2020/0088928 A1
(43) Pub. Date: Mar. 19, 2020

(54) LIGHT-MIXING ROD AND LUMINOUS ARRANGEMENT

(71) Applicant: DIEHL AEROSPACE GMBH, Jeberlingen (DE)

(72) Inventors: Frank Schmid, Poppenricht (DE); Martin Koffler, Hersbruck (DE); Martin Richter, Fuerth (DE)

(73) Assignee: DIEHL AEROSPACE GMBH, Ueberlingen (DE)

(21) Appl. No.: 16/562,517

(22) Filed: Sep. 6, 2019

(30) Foreign Application Priority Data
Sep. 13, 2018 (DE) DE 102018007244.5

(51) Int. Cl. F21V 8/00

(52) U.S. Cl. CPC G02B 6/0008

(57) ABSTRACT

A light-mixing rod for emitting a homogeneous light beam corresponding to a desired outline shape, said light-mixing rod extending from its first longitudinal end with an entrance face for incident light for forming the light beam along a longitudinal axis to its second longitudinal end with an exit face having the outline shape for emitting the light beam, wherein a first part of the light-mixing rod is made from a first material and a second part of the light-mixing rod with the exit face is made from a second material that is optically more diffuse.

A luminous arrangement contains the light-mixing rod and an optical unit, connected downstream of the exit face in the direction of the longitudinal axis, for the light beam for imaging the exit face on a target face that is situated in a specifiable relative position (R) with respect to the exit face.

### BACKGROUND OF THE INVENTION

The invention relates to a light-mixing rod and to a luminous arrangement.

### DISCUSSION OF THE PRIOR ART

There are various approaches for mixing light, for example using a lens near light sources in combination with a microlens array or by using light-mixing rods. Such a light-mixing rod for homogenizing a light beam is known for example from U.S. Pat. No. 6,890,108 B2.

### SUMMARY OF THE INVENTION

The present invention is directed to mixing light and/or homogenizing it in a better way. More particularly, the present invention is directed to a light-mixing rod for emitting a homogeneous light beam. The light-mixing rod serves for emitting a homogeneous light beam corresponding to a desired outline shape. The light-mixing rod extends from its, or a, first longitudinal end along a longitudinal axis of the light-mixing rod to its, or a, second longitudinal end. The light-mixing rod has, at the first longitudinal end, an entrance face for incident light for forming the light beam. The entrance face extends in particular transversely to the longitudinal axis. The light-mixing rod has, at the second longitudinal end, an exit face for emitting the light beam. Said exit face likewise extends in particular transversely to the longitudinal axis and extends in particular parallel to the entrance face. The exit face has the outline shape.

A first part of the light-mixing rod, in particular a first longitudinal section along the longitudinal axis, is made from a first material and a second part of the light-mixing rod, in particular a second longitudinal section, is made from a second material. The second material is optically more diffuse than the first material. The second part has the exit face.

As compared to the second material, the first material is thus an optically relatively clear material. The “light beam corresponding to a desired outline shape” is to be understood to mean that the exit face has the outline shape and consequently the light beam has, at least at a longitudinal site in the emission direction (in particular in the longitudinal direction), in particular at a site of incidence on a target face or surface, a desired target shape that in particular corresponds to the outline shape. Alternatively or additionally, the longitudinal site can also be a site that is arranged at a distance from the exit face in another way. In particular, it may be a focus site of an optical unit if the light beam, after the exit from the light-mixing rod, passes through the corresponding optical unit. In particular, it is not the light beam that has the outline shape but only the imaged representation thereof on a target face. In other words, the light beam can be imaged such that it corresponds to a desired outline shape.

The first part in the light-mixing rod thus serves in particular primarily for light mixing or light homogenization. The second part serves in particular primarily for shaping the outline shape of the light beam or a spot geometry, as will be explained further below. The second part can also contribute to the light mixing/homogenization.

In accordance with the present invention, the result is consequently the creation or utilization of a diffuse part in the light-mixing rod (second part) for shaping any desired outline shapes of the light beam and consequently spot geometries. For the sake of simplicity, the terms “outline shape” and “spot geometry” will be used below partially synonymously. The “spot” is obtained when the light beam is incident on a (scattering) surface in its entirety, in particular perpendicularly. According to the invention, this produces the combination of light homogenization or light mixing (in the case of separate differently coloured components in the incident light) and shaping of the spot geometry in a (single) component part, specifically the light-mixing rod

In accordance with the present invention, the result is minimum space requirement, specifically the combination of light homogenization/mixing and shaping of the spot geometry in one component part. An additional result is the creation of any desired spot geometries. This can be adapted by way of the geometry of the exit face at the second (diffuse) part of the light-mixing rod. The light-mixing rod can be used with a (single or single-coloured) light source producing the incident light. This provides only the shaping of the spot geometry in the light-mixing rod (including homogenization). Alternatively, it is also possible to use a plurality of differently coloured light sources for producing the incident light. This produces light mixing of the individual colours to form a combined colour and the shaping of the spot geometry (including homogenization).

When producing white light using LEDs (light-emitting diodes), the light of a blue LED is converted into white light using specific substances (for example yellow phosphor). When white light is guided through beam-shaping systems, it is partially separated into yellow and blue light (what is known as the “halo effect of blue/yellow colour separation”). The effect becomes more pronounced with each lens/reflector in the beam path. According to the invention, only one (single) component part takes part in the optical processing (e.g. light mixing), which reduces the effect. In addition, the second (diffuse) part in the light-mixing rod ensures a reduction of the effect.

The result is optimized light mixing by combination of the clear (first) and diffuse (second) part or portion in the light-mixing rod. This ratio can be optimized accordingly, for example by a specific ratio of volume shares of the parts relative to one another. The relationship between cross section of the light-mixing rod and extent/arrangement of light sources that produce the incident light is additionally optimizable.

The light-mixing rod is simple to produce: only one (single) component part with in particular simple or clear shapes needs to be produced, for example a part that is first in cross section is configured accordingly and the second part of which develops into a desired outline shape, for example tapers continuously towards a circular cross section (exit face, outline shape).

In other words, according to the invention, the result is a second (diffuse) part being joined onto a clear light-mixing rod (according to the invention now the first part).

In a preferred embodiment, the first material is an optically clear material and the second material is an optically diffuse material. Corresponding materials are commercially available under the designations “optically clear” or “(optical) diffuser”, “volume diffuser” etc., which means that the light-mixing rod is simple to produce.

In one preferred embodiment, the first part and the second part together form the entire light-mixing rod. The light-mixing rod thus has no further components and is therefore particularly simple to produce.

In one preferred embodiment, the second part has a volume share of between 5% and 40% of the light-mixing rod. In particular, the volume share is 10% to 30%, in particular 20%. In particular, tolerances in the single-digit percent range are permissible here. By optimizing the corresponding ratios, optimized homogenization/light mixing and beam shaping can be effected.

In one preferred embodiment, the first part is a first longitudinal section of the light-mixing rod containing the entrance face. Consequently, the relatively clear portion of the light-mixing rod responsible for the light mixing/homogenization of the incident light immediately adjoins the entrance face. As a result, the light is already mixed/homogenized before it enters the beam-shaping part of the light-mixing rod.

In one preferred embodiment, the first part has along the longitudinal axis a constant or conically extending cross section and in particular a constant or conically extending cross-sectional/outline shape. The cross-sectional shape is in particular rectangular or square. Such light-mixing rods have proven themselves for light mixing/homogenization. Consequently, the cross section does not have to be constant. It can also extend conically, for example.

In one preferred embodiment, the second part is a second longitudinal section of the light-mixing rod containing the exit face. Consequently, the beam shaping represents the last section of the light-mixing rod in the beam trajectory, which is why there remains sufficient possibility for—at least partial—light mixing/homogenization for the light that is to be shaped in the preceding beam trajectory.

In one preferred embodiment, the second part is provided outside the exit face with respect to its surface in at least a partial region with at least one light-absorbing and/or light-reflecting element. The portion of the external surface of the second part that is not intended for the exit of the light beam (exit face)—or at least a part thereof—is thus configured to be reflective and/or absorbing itself or is in operative connection with corresponding elements, in particular is covered or coated by such elements. This results in particularly effective beam-shaping.

In one preferred embodiment, the second part adjoins with respect to its outline shape the first part or the outline shape thereof in continuous fashion. That is to say the second part has at the boundary with the first part the same, or the latter's, outline shape. This provides a seamless transition from light from the first part into the second part.

In one preferred embodiment, the second part changes along the longitudinal axis continuously in terms of its outline shape to the exit face. The result is consequently highly continuous and homogeneous beam-shaping.

The present invention is also directed to a luminous arrangement containing the light-mixing rod according to the present invention and an optical unit that is optically connected downstream of the exit face in the emission direction of the light beam in the direction of the longitudinal axis. The optical unit serves to pass on or guide the light beam. The optical unit here serves for imaging the exit face on a target face. The target face is located in a specifiable relative position with respect to the exit face. This can be a real or virtual target face. The target face is in particular a surface to be irradiated using the luminous arrangement. The target face can be a target face for which the luminous arrangement is designed as intended; but the target face can also be part of the luminous arrangement.

The luminous arrangement offers the advantage that a spot (incident or scattered light beam) in accordance with or having the desired outline shape is produced on the target face.

In one preferred embodiment, the optical unit is an imaging lens. Alternatively, the optical unit is a mirror. Alternatively, the optical unit contains an imaging lens and/or a mirror. A corresponding optical unit can be produced particularly simply and cost-effectively.

In one preferred variant of this embodiment, the image plane of the optical unit is located on and/or at a specifiable distance in front of or behind the target face in the direction of the longitudinal axis. Alternatively or additionally, the optical unit is displaced parallel to the longitudinal axis and/or tilted to produce targeted effects in the spot (in particular spot on the target face). In the first case, a spot is produced exactly according to the outline shape as a “sharp” imaged representation, in the second case a more or less unsharp, imprecise, blurred spot with respect to the outline shape (depending on the magnitude of the distance). Depending on personal taste, it is thus possible to produce different optically appealing light spots.

In one preferred embodiment, the luminous arrangement contains a light source for radiating light into the entrance face. Consequently, this produces a complete luminaire for producing the corresponding light beam or spots, as were explained above.

In one preferred embodiment, the light source contains at least two spatially separate individual sources for radiating light into the entrance face. The individual sources during operation in particular radiate their light into the entrance face at different sites. In particular, the individual sources have different light colours. In particular, the individual sources are individually controllable with respect to brightness and/or light quantity. Consequently, it is possible to produce light beams or spots with a particularly high number of variants.

The invention is based on the basic idea of developing a concept for light homogenization/colour mixing. Examples of use are in particular spotlights for the passenger cabin of an aircraft that can emit light in different (commandable) colours.

According to the present invention, the result is in particular a light-mixing rod having a diffuse portion (second part) for producing any desired spot geometries. The invention describes in particular a rod-shaped optical unit (light-mixing rod/luminous arrangement) for mixing light from at least two light sources that emit light in different colours, or for producing spot geometries of any desired shape from the light from at least one light source. The rod-shaped optical unit for this purpose contains or consists of a clear region (for light mixing) and a diffuse part (for shaping the spot geometry).

The light-mixing rod or the luminous arrangement is in particular part of what is known as a “spotlight” for a passenger cabin of an aircraft. Therefore, the invention in particular relates to a corresponding spotlight as well.

### BRIEF DESCRIPTION OF THE DRAWINGS

Further features, effects and advantages of the invention become apparent from the following description of one preferred exemplary embodiment of the invention and the appended figures. In the figures, in each case in a schematic diagram:

FIG. 1 shows a light-mixing rod,

FIG. 2 shows a luminous arrangement with an alternative light-mixing rod.

### DETAILED DESCRIPTION OF THE INVENTION

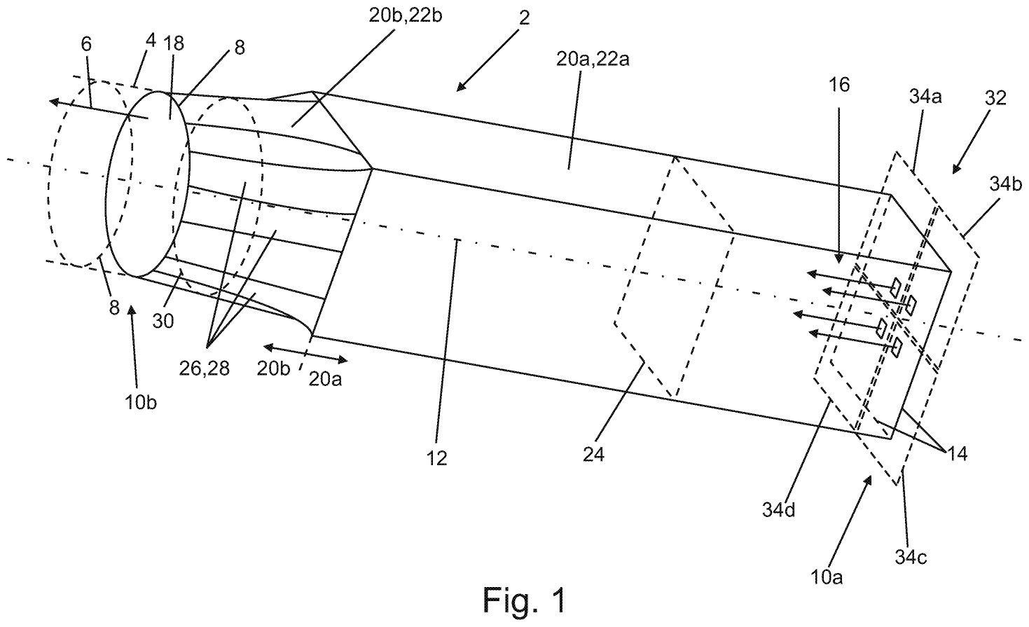

FIG. 1 shows a light-mixing rod 2, which in the operation shown emits a homogeneous light beam 4 (indicated by dashed lines) in the direction of an arrow 6. The light beam 4 here has a desired outline shape 8, in the present case a circular shape.

The light-mixing rod 2 extends from its first longitudinal end 10a along a longitudinal axis 12 to its second longitudinal end 10b. The light-mixing rod 2 has at the first longitudinal end 10a an entrance face 14 for incident light 16 (symbolized by four arrows). The light-mixing rod 2 has, at the second longitudinal end 10b, an exit face 18 for emitting the light beam 4. The exit face 18 here has the outline shape 8.

A first part 20a of the light-mixing rod 2 is made from a first material 22a, in the present case an optically clear material. A second part 20b of the light-mixing rod 2 is made from a second material 22b, in the present case an optically voluminously diffuse material; it is consequently optically more diffuse than the first material 22a. The second part 20b of the light-mixing rod 2 has the exit face 18.

The first part 20a and the second part 20b together form the entire light-mixing rod 2. The second part 20b here has a volume share of 20% of the light-mixing rod 2. The first part 20a is thus a first longitudinal section along the longitudinal axis 12 of the light-mixing rod 2 containing the entrance face 14; the second part 20b is a second longitudinal section containing the exit face 18.

The first part 20a has along the longitudinal axis 12 a constant cross section 24, in the present case with a constant outline shape, here in the shape of a square (indicated in dashed lines.

The second part 20b is provided on its external surface 26, which does not correspond to the exit face 18, with a light-absorbing element 28, in the present case a coating. The second part 20b has an outline shape 30 that adjoins the outline shape of the first part 20a, in the present case the square, in a continuous fashion. The outline shape 30 gradually changes in the direction of the arrow 6 from the square continuously into the outline shape 8, specifically the circle.

FIG. 1 additionally shows a light source 32 for producing the incident light 16 or for radiating the latter into the entrance face 14. The light source 32 has four spatially separate individual sources 34a-d. Each of the individual sources 34a-d emits part of the incident light 16 into the entrance face 14, indicated by a respective arrow. In the example, the individual sources 34a-d are LED sources in the colours blue (34a), green (34b), white (34c) and red (34d) with an individual LED that is in each case indicated only as a rectangle for actual light emission.

In the first part 20a, the individual components of the light 16 are mixed to form a combined colour and are homogenized over the entire cross section 24, and shaped in the second part 20b into the light beam 4 having the desired outline shape 8. As a result, light 16 thus passes from in the present case four light sources (individual sources 34a-d) into the clear first part 20a of the light-mixing rod 2, is mixed there, passes into the diffuse second part 20b of the light-mixing rod 2, and exits at the exit face 18.

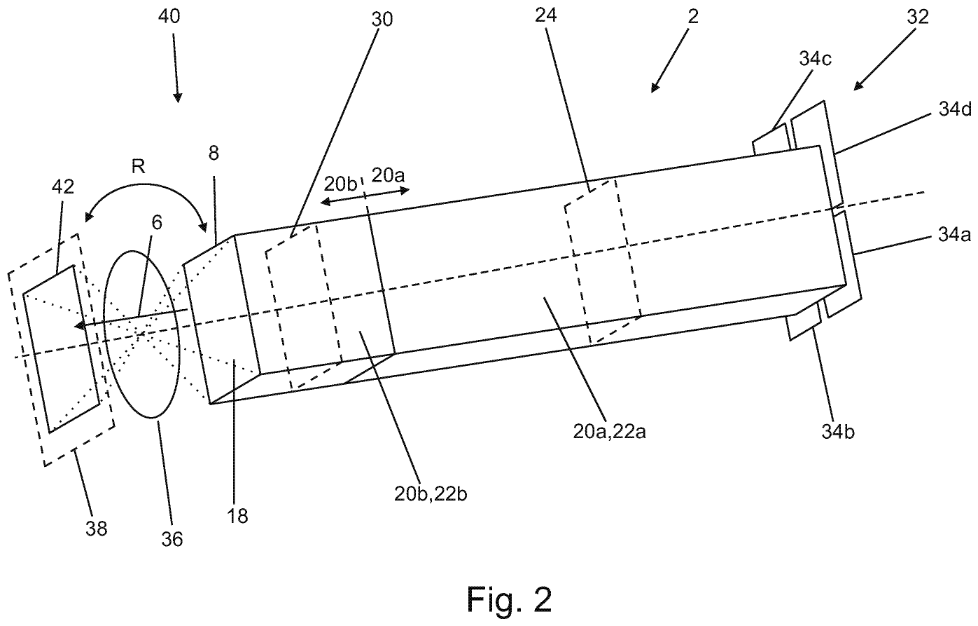

FIG. 2 shows an alternative light-mixing rod 2, which differs from the one in FIG. 1 merely in that the second part 20b is a different shape, specifically has an exit face 18 with a square outline shape 8. Numerous identical constituent parts are not numbered again for clarity. The outline shape 8 is identical to the cross section 24 or the outline shape thereof. The outline shape 30 is therefore constant and likewise corresponds to the outline shape 8 or to that of the cross section 24.

FIG. 2 additionally illustrates an optical unit 36, in the present case an imaging lens, which is optically connected downstream of the exit face 18 in the direction of the longitudinal axis 12 and the arrow 6. The optical unit 36 during operation images the light beam 4 or the exit face 18 on a target face 38, in the present case a surface component part that is to be illuminated of a passenger cabin of an aircraft (indicated only in dashed lines). The imaging process is indicated by dots. The target face 38 is located here in a specifiable relative position R with respect to the exit face 18.

The light-mixing rod 2 and the optical unit 36 together are part of a luminous arrangement 40, here a spotlight in the passenger cabin. The light source 32 is also part of the luminous arrangement 40. The image plane of the optical unit 36 is situated on the target face 38 such that an exact and sharply focused imaged representation 42 of the exit face 18 on the target face 38 is shown in the form of a light spot.

In an alternative embodiment, which is not shown, the light source 32 contains in FIGS. 1 and 2 only two individual sources 34a,b, including a cold-white LED on one side and a warm-white LED on the other.

### LIST OF REFERENCE SIGNS

2 Light-mixing rod
4 Light beam
6 Arrow
8 Outline shape
10a,b First, second longitudinal end
12 Longitudinal axis
14 Entrance face
16 Light (incident)
18 Exit face
20a,b First, second part
22a,b First, second material
24 Cross section
26 Surface
28 Element
30 Outline shape
32 Light source
34a-d Individual source
36 Optical unit
38 Target face
40 Luminous arrangement
42 Imaged representation
R Relative position

What is claimed is:

1. A light-mixing rod for emitting a homogeneous light beam corresponding to a desired outline shape,
wherein the light-mixing rod extends from its first longitudinal end along a longitudinal axis to its second longitudinal end,
wherein the light-mixing rod has at the first longitudinal end an entrance face for incident light for forming the light beam,
and has at the second longitudinal end an exit face for emitting the light beam,
wherein the exit face has the outline shape,
wherein a first part of the light-mixing rod is made from a first material and a second part of the light-mixing rod is made from a second material that is optically more diffuse than the first material, and
wherein the second part has the exit face.

2. The light-mixing rod according to claim 1, wherein the first material is an optically clear material and the second material is an optically diffuse material.

3. The light-mixing rod according to claim 1, wherein the first part and the second part together form the entire light-mixing rod.

4. The light-mixing rod according to claim 1, wherein the second part has a volume share of between 5% and 40% of the light-mixing rod.

5. The light-mixing rod according to claim 1, wherein the first part is a first longitudinal section of the light-mixing rod containing the entrance face.

6. The light-mixing rod according to claim 1, wherein the first part has along the longitudinal axis a constant or conically extending cross section.

7. The light-mixing rod according to claim 1, wherein the second part is a second longitudinal section of the light-mixing rod containing the exit face.

8. The light-mixing rod according to claim 1, wherein the second part is provided outside the exit face with respect to its surface in at least a partial region with a light-absorbing and/or light-reflecting element.

9. The light-mixing rod according to claim 1, wherein the second part adjoins with respect to its outline shape the first part in continuous fashion.

10. The light-mixing rod according to claim 1, wherein the second part changes along the longitudinal axis continuously in terms of its outline shape toward the exit face.

11. A luminous arrangement, having a light-mixing rod according to claim 1, and having an optical unit, connected downstream of the exit face in the direction of the longitudinal axis, for the light beam for imaging the exit face on a target face that is situated in a specifiable relative position (R) with respect to the exit face.

12. The luminous arrangement according to claim 11, wherein the optical unit is or contains an imaging lens and/or a mirror.

13. The luminous arrangement according to claim 12, wherein the image plane of the optical unit is located on and/or at a specifiable distance in front of or behind the target face in the direction of the longitudinal axis and/or the optical unit is displaced parallel to the longitudinal axis and/or tilted.

14. The luminous arrangement according to claim 11, wherein said arrangement contains a light source for radiating light into the entrance face.

15. The luminous arrangement according to claim 14, wherein the light source contains at least two spatially separate individual sources for radiating light into the entrance face.
